(19) United States
(12) Patent Application Publication
(10) Pub. No.: US 2022/0114820 A1
(43) Pub. Date: Apr. 14, 2022

(54) METHOD AND ELECTRONIC DEVICE FOR IMAGE SEARCH

(71) Applicant: GUANGDONG OPPO MOBILE TELECOMMUNICATIONS CORP., LTD., Dongguan (CN)

(72) Inventor: Jenhao HSIAO, Palo Alto, CA (US)

(21) Appl. No.: 17/561,423

(22) Filed: Dec. 23, 2021

Related U.S. Application Data
(63) Continuation-in-part of application No. PCT/CN2020/091086, filed on May 19, 2020.

(51) Int. Cl. G06V 20/70; G06N 3/08; G06N 3/04; G06F 16/55; G06F 16/532

(52) U.S. Cl. CPC G06V 20/70; G06N 3/08; G06F 16/532; G06F 16/55; G06N 3/0454

(57) ABSTRACT

Methods and an electronic device for image searches are described. In one example, a method for image search includes: an input image is received, multiple semantic features are extracted from the input image using one or more convolutional layers and one or more fully connected layers of a neural network; processing the multiple semantic features to obtain a binary code by using at least one additional layer of the neural network; the multiple semantic features are processed to obtain a binary code by using at least one additional layer of the neural network; and a hash-based search is performed by using the binary code to retrieve one or more images that includes at least part of the multiple semantic features.

### CROSS-REFERENCE TO RELATED APPLICATIONS

This application is a continuation-in-part of International Application No. PCT/CN2020/091086, filed May 19, 2020, which claims priority to U.S. Provisional Application No. 62/905,031, filed Sep. 24, 2019, the entire disclosures of which are incorporated herein by reference.

### TECHNICAL FIELD

This document generally relates to image search, and more particularly to image searches that use neural networks.

### BACKGROUND

Pattern recognition is the automated recognition of patterns and regularities in data. Automatic recognition of semantic meanings in images has a broad range of applications, such as identification and authentication, medical diagnosis, and defense. Such recognition also has a great business potential in attracting user traffic for online commercial activities.

### SUMMARY

Disclosed are devices and methods for using a neural network to perform fast image searches. The disclosed techniques can be applied in various embodiments, such as online commerce or cloud-base production recommendation applications, to improve image search performance and attract user traffic for online services.

In one example aspect, a method for image search includes receiving an input image, extracting the multiple semantic features from the input image using one or more convolutional layers and one or more fully connected layers of a neural network, processing the multiple semantic features to obtain a binary code by using at least one additional layer of the neural network, and performing a hash-based search using the binary code to retrieve one or more images that includes at least part of the multiple semantic features.

In another example aspect, an electronic device for retrieving product information is disclosed. The electronic device includes a memory and a processor being coupling to the memory, where the memory stores instructions which, when being executed by the processor, cause the processor to implement the following operations: receiving, via a user interface, an input image from a user, where the input image comprises multiple semantic features of a commercial product; extracting the multiple semantic features from the input image using a feature extraction module of a neural network; obtaining a binary representation of the multiple semantic features using an additional layer of the neural network; performing a hash-based search based on the binary representation to retrieve one or more images that comprises at least part of the multiple semantic features, the one or more images each representing the same or a different commercial product; and displaying, based on the one or more retrieved images, relevant product information on the user interface.

In another example aspect, a method for adapting a neural network system for image search is disclosed. The method includes operating a neural network that includes one or more convolutional layers, one or more fully connected layers, and an output layer. The one or more convolutional layers are configured to extract multiple semantic features from an input image, and the one or more fully connected layers and the output layer are configured to classify the multiple semantic features according to a number of labels. The method includes modifying the neural network by adding an additional layer between the one or more fully connected layers and the output layer, and the modified neural network is trained based on one or more loss functions to acquire a trained neural network. The additional layer is configured to generate a binary representation of the multiple semantic features. The method also includes performing a hash-based image search using the trained neural network.

These and other features of the disclosed technology are described in the present document.

### BRIEF DESCRIPTION OF THE DRAWINGS

FIG. 1 illustrates an example Offline-to-Online scenario.

FIG. 2 illustrates an example neural network architecture in accordance with the present technology.

FIG. 3 is a flowchart representation of a method for performing image search in accordance with the present technology.

FIG. 4 is a flowchart representation of another method for performing image search in accordance with the present technology.

FIG. 5 is a flowchart representation of yet another method for performing image search in accordance with the present technology.

FIG. 6 is a block diagram illustrating an example of the architecture for a computer system or other control device that can be utilized to implement various portions of the presently disclosed technology.

### DETAILED DESCRIPTION

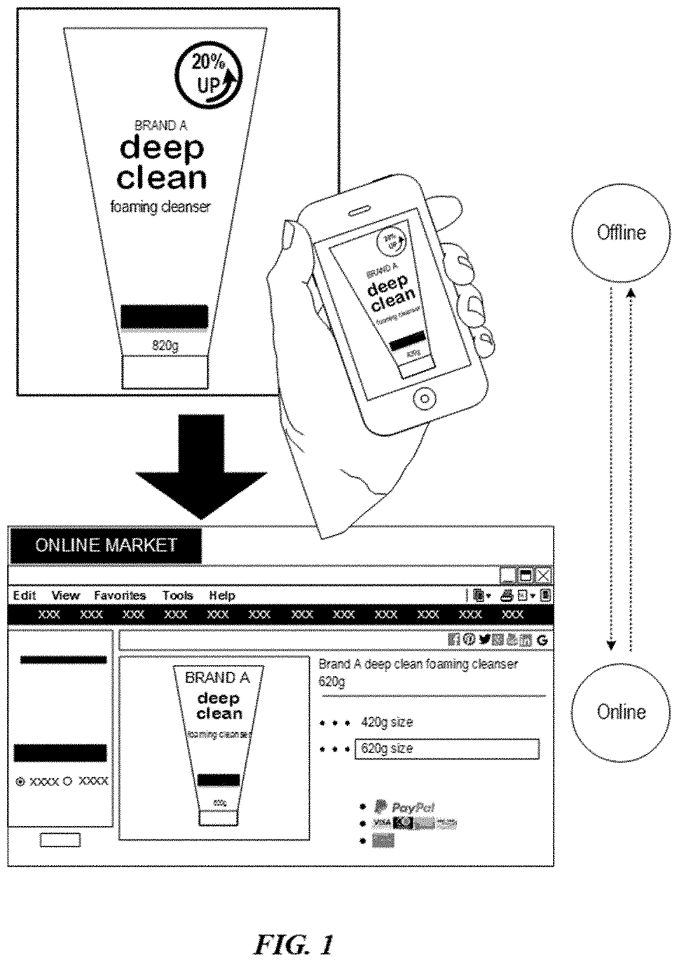

Image search, a content-based image retrieval technique that allows users to discover content related to a specific sample image without providing any search terms, has been adopted by various businesses to facilitate product categorization and to provide product recommendations. Image search can enable Offline-to-Online commerce, a business strategy that finds offline customers and brings them to online services. For example, a user can take a picture of a product in the store and find similar products at online marketplaces for better prices. FIG. 1 illustrates an example Offline-to-Online scenario. A user took a picture of a foaming cleanser in a physical store (i.e., offline). The user then uploaded the picture, via a user interface (e.g., a mobile app), to search for same or similar products online. For example, the picture can be transmitted to a cloud-based image search system that can extract several attributes regarding the product from the image, such as the functional use of the product (e.g., cleanser), the size or weight of the product (e.g., 120 g), and/or the brand of the product (e.g., Brand A). The image search system can retrieve product information of this particular product, or similar products, based on the picture. The retrieved production information is then presented to the user via the user interface. For example, the user can be presented to a list of similar products, each with a link to a corresponding online marketplace. Some of the products may be offered at a better price or packaged in a volume that better suits the user's need. After clicking on a link, the user can be directed to a corresponding online marketplace to make the purchase.

Various techniques have been developed to facilitate effective image searches. For example, global image statistics (e.g., ordinal measure, color histogram, and/or texture) use a single feature vector to describe an entire image. However, global image features may not give adequate descriptions of an image's local structures, such as the size or the brand name of a product as shown in FIG. 1. Local feature descriptors, on the other hand, encode the local properties of images and have been proven to be effective to image matching, object recognition, and copy detection. Compared to global image features, local feature descriptors are resistant to image transformations and occlusions. However, they still cannot bridge the semantic gap in product image search. Recently, deep learning neural networks has become the dominant approach for image search due to their remarkable performance. In particular, the use of convolutional neural networks (CNNs) has demonstrated promising results for single-label image classification. However, CNNs can only achieve limited accuracy in image search due to several reasons. First, the semantic information in an image typically includes several different semantic concepts. A single-label image classification approach is not sufficient to extract meanings for multiple semantic concepts. Currently, conventional CNN models cannot be trivially extended to handle multi-attribute data classification effectively. Second, the retrieval speed of conventional image search methods is largely constrained by the scale of data. Image search systems that perform linear searches can become unacceptably slow given a large amount of image data.

The techniques disclosed herein address these issues by adopting a semantic hash approach that is guided by multi-label semantics in images. In particular, the disclosed techniques can be implemented in various embodiments to employ deep latent training and transfer image semantics into binary representations in a specific domain. The binary representations can be in a form of binary codes and may further include metadata of the semantic meanings. The binary codes can facilitate a hash-based search without a second-stage learning, thereby significantly reducing the retrieval speed of the search system. The disclosed techniques can be easily adapted to existing neural networks, such as many existing applications that use CNNs, to improve the accuracy and speed of the searches. The disclosed techniques can be similarly applied to neural networks other than CNNs.

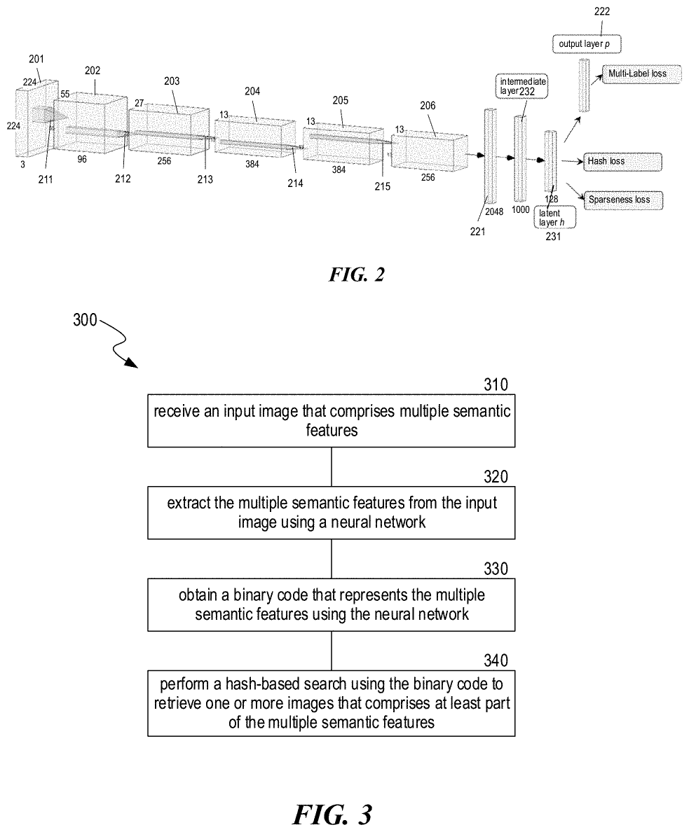

FIG. 2 illustrates an example neural network architecture 200 in accordance with the present technology. The architecture 200 includes several convolutional layers 201, 202, 203, 204, 205, 206 with several global pooling operations 211, 212, 213, 214, 215. The last global pooling operations are followed by one or more fully connected layers 221 and an output layer 222. The convolution layers can be viewed as a feature extractor and the one or more fully connected layers can be viewed as a feature classifier. In some embodiments, the architecture 200 can optionally include one or more fully-connected intermediate layers 232 to avoid accuracy drop due to a sudden dimensionality reduction (e.g., directly from 2048 to 128) and to smooth the learning process.

The architecture 200 further includes a latent layer 231. In some embodiments, the latent layer 232 can use the sigmoid units so the outputs (also referred to as activations) take values in [0, 1] as a binary representation of the multiple semantic labels of the input image. Specifically, neurons in the latent layer are activated by the sigmoid units to output activations of the input image, and the activations are binarized by a threshold to generate the binary representation. The latent layer 232 may be a fully connected layer, and its neuron activities are regulated by the succeeding layer (e.g., the output layer 222) that encodes semantics. The neuron (also referred to as nodes) in the latent layer 232 are activated by sigmoid functions so the activations are approximated to {0,1}. The latent layer can adjust the binary representation based on one or more loss functions (e.g., hash loss, sparseness loss, and/or multi-label loss) to obtain binary codes that can increase the efficiency of the search. In some embodiments, the latent layer 232 can use a step function so that the output takes multiple values (e.g., [0, 1, 2]) as a ternary, quaternary, or other multi-value representation of the multiple semantic labels of the input image. For example, 0 can indicate that the feature is absent from the image, 2 can indicate that the feature is present in the image, and 1 can indicate that the feature is likely (e.g., with a probability of 70%) to be present in the image. The latent layer can adjust the multi-value representation based on one or more loss functions (e.g., has loss, sparseness loss, and/or multi-label loss) to obtain codes that can increase the efficiency of the search. It is noted that the subsequent discussions focus on the binary representation of the learning results (that is, sigmoid units are used). However, the techniques can be similarly applied to systems that uses other types of multi-value representations of the semantic labels of the input image.

The binary representation of the image allows the extraction of multi-label semantics of the image. For example, let D={yₙₘ}^{N×m} denote the label vectors associated with N images of M class labels, where N>1 and M>1. The N images which are annotated with the M class labels are taken as training data. yₙ represents a m-dimensional label vector of the n-th image. Each entry of yₙ indicates whether a particular label is present in an image or not, with 1 for the presence and 0 for the absence. Multiple entries of yₙ could be 1 in multi-label classification where images are associated with multiple classes. Using the network architecture disclosed herein, an image search system can learn M separate binary classifiers, one for each class. Given the n-th image sample with the label yₙₘ, the m-th output node is to produce a positive response (i.e., y̅ₙₘ≥1) for the desired label yₙₘ=1 and a negative response (i.e., y̅ₙₘ≤0) for yₙₘ=0.

In some embodiments, a precise matching of the semantics may not be needed. For example, as shown in FIG. 1, the user may want to include similar sizes of the product in the search results. To provide an accurate mapping of the semantic meaning while improving search efficiency, the binary codes can be designed to respect the semantic similarities between image labels. Images that share common class labels are mapped to same (or similar) binary codes. In achieving so, a cross-entropy loss function, which measures the performance of a classification model, can be used to represent the relationship between multiple labels as well as the binary codes. The cross entropy function is defined on multi-label classification error, which can also be referred to as a first loss function. For example, the multi-label loss for each output node in the output layer 222 can be defined as:

$$Multilabel Loss = \frac{1}{m} {\sum }_{n} {\sum }_{m} - λ {y}_{n m} log ( {p}_{n m} ) - ( 1 - {y}_{n m} ) log ( 1 - {p}_{n m} ) \qquad Eq . ( 1 )$$

Here, yₙₘ is the binary indicator (0 or 1) indicating whether a n-th image is annotated with a m-th label, pnm is the predicted probability of the m-th attribute (i.e., m-th label) of the n-th image, and λ, is a parameter to control the weighting of positive labels. This loss function models the relationship between the various labels and the binary codes by assuming that the semantic labels can be derived from the latent K nodes (at the latent layer) with each on and off. This implies that through an optimization of a loss function defined on the classification error, it can be ensured that semantically similar images are mapped to similar binary codes. Therefore, when trained for a classification task, a network with a latent layer learns the binary attributes implicitly without the need of constructing the codes in a separate stage or dramatically altering the network model with different objective settings.

To leverage the binary representation for hash-based searches, it is desirable to evenly distributed and discriminative bits in the binary codes so that the codes can fall into different hash buckets to achieve faster search performance. Considering the variance for each bin, the higher the entropy is, the more information the binary codes express. Accordingly, the binary codes can be enhanced by making each bit has 50% probability of being one or zero. To obtain the desired distribution of the bits, a second loss function can be defined as follows:

$$HashLoss = \frac{1}{k} {\sum }_{n} {‖ {h}_{n} - 0.5 l ‖}^{2} \qquad Eq . ( 2 )$$

Here, l is the k-dimensional vector with all elements being 1, hₙ represents activations of n-th image in the latent layer, i.e., the output binary codes of the n-th image from the latent layer, and k represents a number of bits in the binary representation, i.e., the number of nodes at latent layer. By maximizing the second loss function, i.e., a constraint of maximizing the sum of squared errors between the latent layer activations and 0.5, the activations of the latent layer hₙ is encouraged to approximate to {0,1}. However, hash loss function alone may not be able to generate a uniformly distributed hash codes for the whole dataset. To further boost the effectiveness of the hash code, a third loss function can be defined as:

SparseLoss=Σₙ mean(hₙ)−0.5 Eq. (3)

Here, mean (⋅) computes the average of the elements in a vector. The sparse loss function favors binary codes with an equal number of 0's and 1's as its learning objective by minimizing the third loss function. The sparse loss function thus can enlarge the minimal gap and make the codes more uniformly distributed in each hash bucket. For example, assuming that a binary code has 100 bits. Given the loss functions shown in Eq. (2) and Eq. (3), the number of 1's in the resulting binary code can be 40 to 60 while the corresponding number of 0's in the resulting binary code can be 60 to 40. The 0's are positioned between the 1's, creating a substantial even spacing between adjacent 1's. In some embodiments, the consecutive number of 0's or 1's does not exceed 10 bits so as to achieve the even spacing of the binary code.

Combing these two constraints of maximizing the second loss function and minimizing the third loss function, the binary codes outputted from the latent layer is encouraged to close to a length-K binary string with a 50% change of each bit being 0 or 1.

The total loss function can be defined as a combination of all three loss functions:

TotalLoss=α·MutilabelLoss+β·HashLoss+γ·SparseLoss

Here, α, β, and γ are parameters that control the weighting of each term. For example, β may be negative, α and ρ may be positive and the neural network is trained by minimizing the total loss function. The MultilabelLoss is configured to ensure that semantically similar images are mapped to similar binary codes, the HashLoss is configured to encourage the activations of the units in latent layer to be close to either 0 or 1, and the SparseLoss is configured to ensure that the output of each node at the latent layer has s nearly 50% chance of being 0 or 1.

After the neural network is trained, images are fed to the network during the testing stage to extract the activations of the latent layer. Then, the binary codes of an image Iₙ, denoted by bₙ, can be obtained by quantizing the extracted activations via the following equation:

bₙ=sign(hₙ−0.5) Eq. (3)

Here, hₙ is the activation of the latent layer H. Function sign(.) performs element-wise operations for a matrix or a vector: sign(v)=1 if v>0 and 0 otherwise. In some embodiments, the Hamming distance is used to measure the similarity between two binary codes. The smaller the Hamming distance is, the higher level the similarity of the two images is. The binary codes of each of the images in the database can be previously acquired by the above neural network architecture 200 with the latent layer. After a query image is acquired, the binary codes of the query image can be acquired by the above neural network architecture 200 with the latent layer, and then the Hamming distance between the binary codes of the query image and the binary codes of the images in the database can be calculated, respectively. To retrieve relevant images to a query, the images in the database are ranked according to their distance to the query and the top k images in the list are returned (k>0), where the top k images have relatively small Hamming distances. It can be understood that the returned images can also be the images in the database whose distance is larger than a preset threshold.

FIG. 3 is a flowchart representation of a method 300 for performing an image search in accordance with the present technology. The method 300 includes, at operation 310, receiving an input image that includes multiple semantic features. The method 300 includes, at operation 320, extracting the multiple semantic features from the input image using one or more convolutional layers and one or more fully connected layers of a neural network. The method 300 includes, at operation 330, obtaining a binary code that represents the multiple semantic features using at least one additional layer of the neural network. Each bit in the binary code has an equal probability of being a first value or a second value so that the bits in the binary code are substantially evenly distributed to be more likely to fall into different hash buckets. The method 300 also includes, at operation 340, performing a hash-based search based on the binary code to retrieve one or more images that includes at least part of the multiple semantic features. In some embodiment, as shown in FIG. 1, the input image represents a commercial product. The product can include household items, consumer electronics, appliances, home furnishings, or any items that can be located in an offline, physical store. The multiple semantic features include at least a size of the commercial product, a brand of the commercial product, or a functional use of the commercial product so that the user can determine whether an online service provides a better option for purchasing the commercial product. For example, physical stores may carry a limited number of product options due to factors such as store space and/or logistics costs. Using image searches, customers can find a wide range of similar products of different brands, different styles, different sizes, and/or different price points at online marketplaces that better suit their needs.

In some embodiments, the first value (e.g., 1) in the binary code indicates a corresponding feature is present in the input image, and the second value (e.g., 0) in the binary code indicates a corresponding feature is absent in the input image. In some embodiment, the method includes representing similar semantic features using a same binary code. The similar semantic features can be identified by the one additional layer of the neural network based on a cross-entropy loss function. The cross-entropy loss function can be defined based on an average of multiple cross-entropy loss functions for the multiple semantic features.

In some embodiments, bits in the binary code are substantially evenly distributed and are obtained via the one additional layer of the neural network based on one or more loss functions. The one or more loss functions can include a first loss function that encourages half of the bits in the binary code to be the first value and another half of the bits in the binary code to be the second value, thereby generating a uniformly distributed hash codes for the input image. The one or more loss functions can also include a second loss function that is configured to change a spacing between one or more bits of the first value and one or more bits of the second value. In some embodiments, the bits in the binary code are generated based on a total loss function that is a weighted sum of a first loss function representing the multiple semantic features, a second loss function that encourages an equal number of bits of the first value and the second value, and a third loss function that changes a spacing between the bits of the first value and the second value. In some embodiments, the method includes measuring a Hamming distance between two binary codes to retrieve the one or more images.

It should be clear for those skilled in the art that the description of the specific processes of the above method can be referred to the corresponding implementations described above, which will not be repeated here again, for simple and concise description.

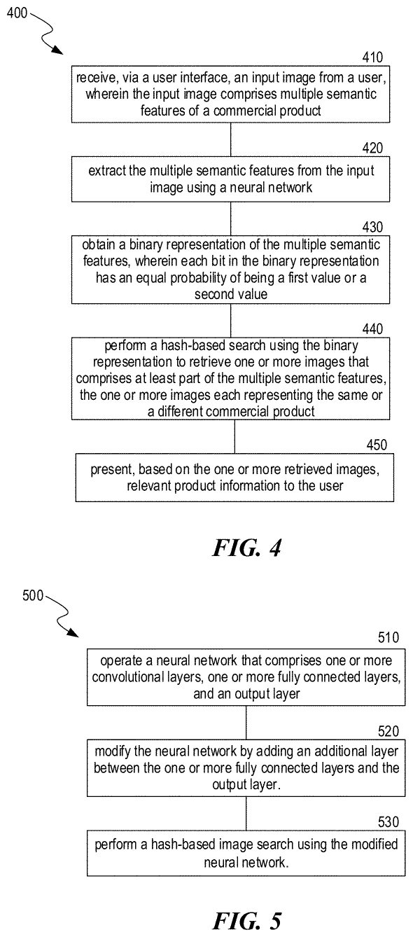

FIG. 4 is a flowchart representation of a method 400 for performing an image search in accordance with the present technology. The method 400 includes, at operation 410, receiving, via a user interface, an input image from a user, where the input image includes multiple semantic features of a commercial product. The method 400 includes, at operation 420, extracting the multiple semantic features from the input image using a neural network. The method 400 includes, at operation 430, obtaining a binary representation of the multiple semantic features, where each bit in the binary representation has an equal probability of being a first value or a second value. The method 400 includes, at operation 440, performing a hash-based search using the binary representation to retrieve one or more images that includes at least part of the multiple semantic features, the one or more images each representing the same or a different commercial product. The method 400 also includes, at operation 540, presenting, based on the one or more retrieved images, relevant product information to the user via the user interface.

In some embodiments, where the multiple semantic features include at least a size of the commercial product, a brand of the commercial product, or a functional use of the commercial product. In some embodiments, the first value in the binary representation indicates a corresponding feature is present in the input image, and the second value in the binary representation indicates a corresponding feature is absent in the input image. In some embodiments, similar semantic features are represented using a same binary code based on a multi-feature cross-entropy loss function. In some embodiments, bits in the binary representation are substantially evenly distributed. In some embodiments, the method further includes adjusting the bits in the binary representation based on one or more loss functions. In some embodiments, the one or more loss functions includes a first loss function that encourages half of the bits in the binary representation to be the first value and another half of the bits in the binary representation to be the second value. The one or more loss functions may also include a second loss function that adjusts a spacing between one or more bits of the first value and one or more bits of the second value. In some embodiments, bits of the binary representation are generated based on a total loss function that is a weighted sum of a first loss function representing the multiple semantic features, a second loss function that encourages an equal number of bits of the first value and the second value in the binary representation, and a third loss function that adjusts a spacing between the bits of the first value and the second value.

FIG. 5 is a flowchart representation of a method 500 for performing an image search in accordance with the present technology. The method 500 includes, at operation 510, operating a neural network that includes one or more convolutional layers, one or more fully connected layers, and an output layer. The one or more convolutional layers are adapted to extract multiple semantic features from an input image, and the one or more fully connected layers are adapted to classify the multiple semantic features. The method 500 includes, at operation 520, modifying the neural network by adding an additional layer between the one or more fully connected layers and the output layer. The additional layer is adapted to generate a binary representation of the multiple semantic features based on one or more loss functions. The method 500 also includes, at operation 530, performing a hash-based image search using the modified neural network.

In some embodiments, the additional layer is configured to generate the binary representation based on a sigmoid unit. In some embodiments, the one or more loss functions include a multi-feature cross entropy function. The multi-feature cross entropy function can be defined as

$$Multilabel Loss = \frac{1}{m} {\sum }_{n} {\sum }_{m} - λ {y}_{n m} log ( {p}_{n m} ) - ( 1 - {y}_{n m} ) log ( 1 - {p}_{n m} ) ,$$

where yₙₘ is a binary indicator of the first value or the second value, pnm is a predicted probability of m-th attribute of n-th image, and λ is a parameter to control a weighting of the multiple semantic features. In some embodiments, the one or more loss functions include a second loss function that encourages half of the bits in the binary representation to be the first value and another half of the bits in the binary representation to be the second value. The second loss function can be defined as

$$Hash Loss = \frac{1}{k} {\sum }_{n} {‖ {h}_{n} - 0.5 l ‖}^{2} ,$$

where l is a k-dimensional vector with all elements being 1. In some embodiments, the one or more loss functions includes a third loss function that adjusts a spacing between one or more bits of the first value and one or more bits of the second value. The third loss function can be defined as SparseLoss=Σₙ mean(hₙ)−0.5.

It is thus evident that the disclosed techniques can achieve significant improvement of search accuracy by adopting a binary code that accurately represents multiple semantic labels of the image. A fast hash-based search can be enabled by the binary code because the binary codes are likely to fall into different hash buckets due to the fact that bits in a binary code are substantially uniformly distributed. Furthermore, the disclosed techniques do not require significant changes to existing networks. Thus, adaptation of existing neural networks only requires adding a couple of layers (e.g., the latent layer and optionally the intermediate layer) with a short amount of training time.

The disclosed techniques can achieve substantial speed-up in image retrieval as compared to a conventional exhaustive search. In particular, the retrieval time using the disclosed techniques can be substantially independent of the size of the dataset—millions of images can be searched in a few milliseconds while attaining search accuracy.

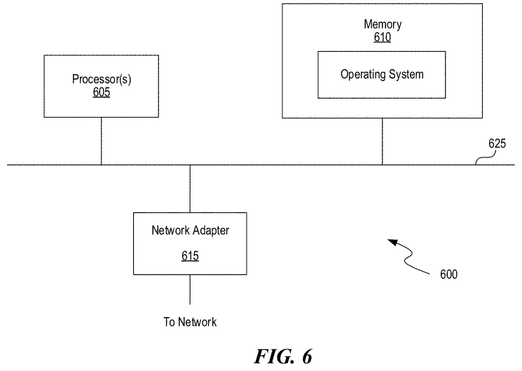

FIG. 6 is a block diagram illustrating an example of the architecture for a computer system or other control device 600 that can be utilized to implement various portions of the presently disclosed technology, such as the neural network architecture as shown in FIG. 2. In FIG. 6, the computer system 600 includes one or more processors 605 and memory 610 connected via an interconnect 625. The interconnect 625 may represent any one or more separate physical buses, point to point connections, or both, connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 605 may include central processing units (CPUs) to control the overall operation of, for example, the host computer. The processor(s) 605 can also include one or more graphics processing units (GPUs). In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 can be or include the main memory of the computer system. The memory 610 represents any suitable form of random access memory (RAM), read-only memory (ROM), flash memory, or the like, or a combination of such devices. In use, the memory 610 may contain, among other things, a set of machine instructions which, upon execution by processor 605, causes the processor 605 to perform operations to implement embodiments of the presently disclosed technology.

Also connected to the processor(s) 605 through the interconnect 625 is a (optional) network adapter 615. The network adapter 615 provides the computer system 600 with the ability to communicate with remote devices, such as the storage clients, and/or other storage servers, and may be, for example, an Ethernet adapter or Fiber Channel adapter.

The disclosed techniques can be implemented in various embodiments to optimize one or more aspects (e.g., performance, the number of classes/characteristics, accuracy) of the training process of an AI system that uses neural networks, such as an image search system. It is further noted that while the provided examples focus on searching images, the disclosed techniques are not limited in the field of sign language translation and can be applied in other areas that require binary codes of images with semantic information. For example, the disclosed techniques can be used in various embodiments to train a pattern and image search system that includes a neural network learning engine.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In an embodiment of the disclosure, an electronic device for retrieving product information is provided. The electronic device includes a memory and a processor being coupling to the memory, where the memory stores instructions which, when being executed by the processor, cause the processor to implement the following operations. An input image from a user is received via a user interface, where the input image includes multiple semantic features of a commercial product. The multiple semantic features are extracted from the input image using a feature extraction module of a neural network. A binary representation of the multiple semantic features is obtained by using an additional layer of the neural network. A hash-based search based on the binary representation is performed to retrieve one or more images that includes at least part of the multiple semantic features, and the one or more images each represents the same or a different commercial product. Relevant product information is displayed on the user interface, based on the one or more retrieved images.

Furthermore, the neural network is trained based on a total loss function that is a weighted sum of a first loss function for multi-label classification error, a second loss function that encourages activations of the one or more additional layer to approximate to a first value or a second value, and a third loss function that encourage each bit in the binary representation to be substantially evenly distributed.

In an embodiment of the disclosure, a method for adapting a neural network system for image search is provided. A neural network is operated. The neural network includes one or more convolutional layers, one or more fully connected layers, and an output layer. The one or more convolutional layers are configured to extract multiple semantic features from an input image, and the one or more fully connected layers and the output layer are configured to classify the multiple semantic features according to a plurality of labels. The neural network is modified by adding an additional layer between the one or more fully connected layers and the output layer. The modified neural network is trained based on one or more loss functions, and acquiring a trained neural network. The additional layer is configured to generate a binary representation of the multiple semantic features. A hash-based image search is performed by using the trained neural network.

Furthermore, the additional layer is configured to generate the binary representation based on a sigmoid unit.

Furthermore, the one or more loss functions comprises a cross entropy function defined on multi-label classification error. The modified neural network is trained on a plurality of training images annotated with a plurality of sample labels, by minimizing the cross entropy function.

Furthermore, the output layer in the modified neural network is configured to receive and process the binary representation from the additional layer, and output a plurality of predicted probabilities corresponding to the plurality of labels respectively. The cross entropy function is defined as the following equation:

$$Multilabel Loss = \frac{1}{m} {\sum }_{n} {\sum }_{m} - λ {y}_{n m} log ( {p}_{n m} ) - ( 1 - {y}_{n m} ) log ( 1 - {p}_{n m} ) ,$$

where yₙₘ is a binary indicator indicating whether a n-th image is annotated with a m-th label, pnm is the predicted probability of m-th label of n-th image, and λ, is a parameter to control a weighting of the multiple semantic features.

Moreover, the one or more loss functions further comprise a second loss function that encourages activations of the one or more additional layer to approximate to a first value or a second value. The second loss function is defined as the following equation:

$$Hash Loss = \frac{1}{k} {\sum }_{n} {‖ {h}_{n} - 0.5 l ‖}^{2} ,$$

where l is a k-dimensional vector with all elements being 1, hₙ represents activations of n-th image in the additional layer, and k represents a number of bits in the binary representation.

The one or more loss functions further comprises a third loss function that encourages half of the bits in the binary representation to be a first value and another half of the bits in the binary representation to be a second value. The third loss function is defined as the following equation:

SparseLoss=Σₙ mean(hₙ)−0.5,

where hₙ represents activations of n-th image of the additional layer.

The one or more loss functions is defined as a weighted sum of a first loss function, a second loss function, and a third loss function; wherein the first loss function is defined on multi-label classification error, the second loss function is configured to encourage activations of the additional layer to approximate to a first value or a second value, and the third loss function is configured to encourage each bit in the binary representation to be substantially evenly distributed.

The performing a hash-based image search using the trained neural network includes the following operations. A target image and a plurality of images waiting to be searched are acquired; a binary representation of the target image and binary representations of the plurality of images waiting to be searched are acquired by using the trained neural network; Hamming distances between the binary representation of the target image and the binary representations of the plurality of images waiting to be searched are measured, and the one or more images are retrieved according to the Hamming distances.

It should be clear for those skilled in the art that the description of the specific processes of the above method can be referred to the corresponding implementations described above, which will not be repeated here again, for simple and concise description.

It is intended that the specification, together with the drawings, be considered exemplary only, where exemplary means an example.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a selected number of implementations and examples are described and other implementations, enhancements and variations can be made based on what is described and illustrated in this patent document.

What is claimed is:

1. A method for image search, comprising:
receiving an input image;
extracting multiple semantic features from the input image using one or more convolutional layers and one or more fully connected layers of a neural network;
processing the multiple semantic features to obtain a binary code by using at least one additional layer of the neural network; and
performing a hash-based search using the binary code to retrieve one or more images that comprises at least part of the multiple semantic features.

2. The method of claim 1, wherein the at least one additional layer is configured to represent similar semantic features using a same binary code.

3. The method of claim 1, wherein the neural network further comprises an output layer fully connected with the at least one addition layer, and the output layer is configured to classify the input image with a plurality of semantic labels.

4. The method of claim 3, wherein the neural network is trained by minimizing a first loss function defined on multi-label classification error.

5. The method of claim 1, wherein nodes in the at least one additional layer are activated by a sigmoid unit to output activations being approximated to a first value or a second value, and the activations are binarized by a threshold to generate the binary code; and
wherein the method further comprises:
training the neural network based on one or more loss functions for the at least one additional layer.

6. The method of claim 5, wherein the one or more loss functions comprises a first loss function that encourage the activations to approximate to a first value or a second value.

7. The method of claim 5, wherein the one or more loss functions comprises a second loss function that encourages each bit in the binary code to be substantially evenly distributed.

8. The method of claim 1, wherein the binary code is generated based on a total loss function that is a weighted sum of a first loss function defined on multi-label classification error, a second loss function that encourages encourage activations of the one or more additional layer to approximate to a first value or a second value, and a third loss function that encourages each bit in the binary code to be substantially evenly distributed.

9. The method of claim 1, wherein the performing a hash-based search using the binary code to retrieve one or more images that comprises at least part of the multiple semantic features comprises:
measuring a Hamming distance between two binary codes to retrieve the one or more images.

10. The method of claim 1, wherein the input image represents a commercial product, and wherein the multiple semantic features are configured to classify the input image with labels comprises at least a size of the commercial product, a brand of the commercial product, or a functional use of the commercial product.

11. An electronic device for retrieving product information, comprising:
a memory and a processor being coupling to the memory;
wherein the memory stores instructions which, when being executed by the processor, cause the processor to implement operations comprising:
receiving, via a user interface, an input image from a user, wherein the input image comprises multiple semantic features of a commercial product;
extracting the multiple semantic features from the input image using a feature extraction module of a neural network;
obtaining a binary representation of the multiple semantic features using an additional layer of the neural network;
performing a hash-based search based on the binary representation to retrieve one or more images that comprises at least part of the multiple semantic features, the one or more images each representing the same or a different commercial product; and
displaying, based on the one or more retrieved images, relevant product information on the user interface.

12. The electronic device of claim 11, wherein the neural network is trained based on a total loss function that is a weighted sum of a first loss function defined on multi-label classification error, a second loss function that encourages activations of the one or more additional layer to approximate to a first value or a second value, and a third loss function that encourage each bit in the binary representation to be substantially evenly distributed.

13. A method for adapting a neural network system for image search, comprising:
operating a neural network that comprises one or more convolutional layers, one or more fully connected layers, and an output layer, wherein the one or more convolutional layers are configured to extract multiple semantic features from an input image, and the one or more fully connected layers and the output layer are configured to classify the multiple semantic features according to a plurality of labels;
modifying the neural network by adding an additional layer between the one or more fully connected layers and the output layer, and training the modified neural network based on one or more loss functions, and acquiring a trained neural network, wherein the additional layer is configured to generate a binary representation of the multiple semantic features; and
performing a hash-based image search using the trained neural network.

14. The method of claim 13, wherein nodes in the additional layer are activated by a sigmoid unit to output activations being approximated to a first value or a second value, and the activations are binarized by a threshold to generate the binary representation.

15. The method of claim 13, wherein the one or more loss functions comprises a cross entropy function defined on multi-label classification error; and
the training the modified neural network based on one or more loss functions comprising:
training the modified neural network on a plurality of training images annotated with a plurality of sample labels, by minimizing the cross entropy function.

16. The method of claim 15, wherein the output layer in the modified neural network is configured to receive and process the binary representation from the additional layer, and output a plurality of predicted probabilities corresponding to a plurality of labels respectively; and
wherein the cross entropy function is defined as the following equation:
$$Multilabel Loss = \frac{1}{m} {\sum }_{n} {\sum }_{m} - λ {y}_{n m} log ( {p}_{n m} ) - ( 1 - {y}_{n m} ) log ( 1 - {p}_{n m} ) ,$$
where yₙₘ is a binary indicator indicating whether a n-th image is annotated with a m-th label, pₙₘ is the predicted probability of m-th label of n-th image, and λ is a parameter to control a weighting of the multiple semantic features.

17. The method of claim 13, wherein the one or more loss functions further comprise a second loss function that encourages activations of the one or more additional layer to approximate to a first value or a second value; and
wherein the second loss function is defined as the following equation:
$$Hash Loss = \frac{1}{k} {\sum }_{n} {‖ {h}_{n} - 0.5 l ‖}^{2} ,$$
where l is a k-dimensional vector with all elements being 1, hₙ represents activations of n-th image in the additional layer, and k represents a number of bits in the binary representation.

18. The method of claim 13, wherein the one or more loss functions further comprises a third loss function that encourages half of the bits in the binary representation to be a first value and another half of the bits in the binary representation to be a second value; and
wherein the third loss function is defined as the following equation:
SparseLoss=Σₙ mean(hₙ)−0.5,
where hₙ represents activations of n-th image of the additional layer.

19. The method of claim 13, wherein the one or more loss functions is defined as a weighted sum of a first loss function, a second loss function, and a third loss function; wherein the first loss function is defined on multi-label classification error, the second loss function is configured to encourage activations of the additional layer to approximate to a first value or a second value, and the third loss function is configured to encourage each bit in the binary representation to be substantially evenly distributed.

20. The method of claim 13, wherein the performing a hash-based image search using the trained neural network comprises:
acquiring a target image and a plurality of images waiting to be searched; acquiring a binary representation of the target image and binary representations of the plurality of images waiting to be searched by using the trained neural network;
measuring Hamming distances between the binary representation of the target image and the binary representations of the plurality of images waiting to be searched, and retrieving the one or more images according to the Hamming distances.
